(19) United States
(12) Patent Application Publication
(10) Pub. No.: US 2010/0020430 A1
(43) Pub. Date: Jan. 28, 2010

(54) CONTROL DEVICE AND STORAGE DEVICE

(75) Inventor: Yasuto Aramaki, Kawasaki (JP)

Correspondence Address: GREER, BURNS & CRAIN, 300 S WACKER DR, 25TH FLOOR, CHICAGO, IL, 60606, US

(73) Assignee: FUJITSU LIMITED, Kawasaki (JP)

(21) Appl. No.: 12/570,249

(22) Filed: Sep. 30, 2009

Related U.S. Application Data
(63) Continuation of application No. PCT/JP2007/060912, filed on May 29, 2007.

(51) Int. Cl. G11B 5/09

(52) U.S. Cl. 360/53; G9B/5.033

(57) ABSTRACT

According to one embodiment, a control device of a storage device that is supplied with a power supply voltage from a power supply and writes write data to a recording medium, includes an input module and a controller. The input module receives a comparison result obtained by comparing the power supply voltage with a threshold voltage. The controller saves the write data to a save area when determining, immediately before writing the write data to the recording medium, that the power supply voltage is lower than the threshold voltage based on the comparison result, and writes the write data saved in the save area to the recording medium.

### CROSS-REFERENCE TO RELATED APPLICATIONS

This application is a continuation of PCT international application Ser. No. PCT/JP2007/060912 filed on May 29, 2007 which designates the United States, incorporated herein by reference.

### BACKGROUND

1. Field

One embodiment of the invention relates to a control device and a storage device, and more particularly, to a control device for preventing data corruption due to power supply cut off and a storage device with the control device.

2. Description of the Related Art

If a power supply connected to a storage device such as a magnetic disk device is turned off during writing of data to a recording medium such as a magnetic disk, the data being written is corrupted. FIG. 1 is a chart for explaining the operation of a magnetic disk device upon cut-off of power supply. In FIG. 1, a power supply voltage gradually decreases due to power supply cut off and, at time TD, reaches a value below which the magnetic disk device is inoperative (hereinafter, “inoperative voltage value”). Below the inoperative voltage value, a write gate signal WG for use in writing of data to a sector of the magnetic disk is not generated successfully. This causes corruption of the write data of the corresponding sector. After the corruption, the sector cannot be read.

To prevent data corruption of a sector due to power supply cut off, it is necessary to predict cut-off of power supply and to interrupt write operation on sector basis. In this case, however, if predictive accuracy is low, the write operation may be unnecessarily interrupted, or, on the contrary, the power supply may be turned off before the write operation is interrupted. A complicated mechanism is required to improve predictive accuracy. However, even with improved predictive accuracy, it is impossible to reliably predict every cut-off of power supply.

To compensate for low predictive accuracy, a built-in power supply, such as a battery, may be provided in a magnetic disk device to enable the operation of the disk device for the minimum time to prevent data corruption after power supply cut off. However, providing such a built-in power supply in a magnetic disk device goes against the need for size and cost reduction.

For example, Japanese Patent Application Publication (KOKAI) Nos. 63-78211 and 9-35417 discloses conventional technologies to cope with power supply cut off in a disk device.

With the conventional technologies, it is impossible to reliably prevent data corruption due to power supply cut off and also to meet the need for size and cost reduction in a storage device.

### BRIEF DESCRIPTION OF THE SEVERAL VIEWS OF THE DRAWINGS

A general architecture that implements the various features of the invention will now be described with reference to the drawings. The drawings and the associated descriptions are provided to illustrate embodiments of the invention and not to limit the scope of the invention.

FIG. 1 is an exemplary chart for explaining the operation of a magnetic disk device upon cut-off of power supply according to a conventional technology;

FIG. 2 is an exemplary block diagram of a storage device according to an embodiment of the invention;

FIG. 3 is an exemplary chart for explaining operation upon cut-off of power supply in the embodiment;

FIG. 4 is an exemplary diagram for explaining saving management information in the embodiment;

FIG. 5 is an exemplary plan view of areas on a magnetic disk in the embodiment;

FIG. 6 is an exemplary flowchart of the write operation of the magnetic disk device in the embodiment;

FIG. 7 is an exemplary diagram for explaining writing of write data to a selected save area in the embodiment;

FIG. 8 is an exemplary diagram for explaining writing of the write data saved in the selected save area to a user-use area on the magnetic disk in the embodiment; and

FIG. 9 is an exemplary flowchart of the operation of the magnetic disk device upon turning on the power supply in the embodiment.

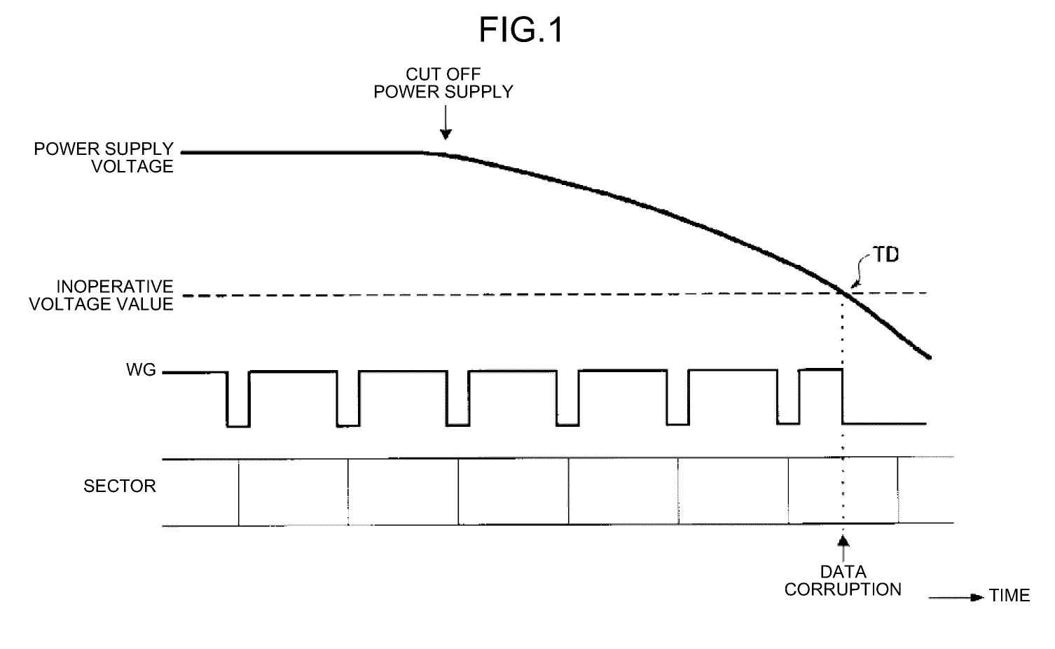

### DETAILED DESCRIPTION

Various embodiments according to the invention will be described hereinafter with reference to the accompanying drawings. In general, according to one embodiment of the invention, a control device of a storage device that is supplied with a power supply voltage from a power supply and writes write data to a recording medium, comprises an input module and a controller. The input module is configured to receive a comparison result obtained by comparing the power supply voltage with a threshold voltage. The controller is configured to save the write data to a save area when determining, immediately before writing the write data to the recording medium, that the power supply voltage is lower than the threshold voltage based on the comparison result, and write the write data saved in the save area to the recording medium.

According to another embodiment of the invention, a storage device that is supplied with a power supply voltage from a power supply and writes write data to a recording medium, comprises a processor, a memory, a comparator, and a controller. The processor is configured to control the storage device. The memory is configured to store data and a program to be executed by the processor. The comparator is configured to compare the power supply voltage with a threshold voltage and output a comparison result. The controller is configured to, under the control of the processor, save the write data to a save area when determining, immediately before writing the write data to the recording medium, that the power supply voltage is lower than the threshold voltage based on the comparison result, and write the write data saved in the save area to the recording medium. The save area comprises an area on the recording medium other than an area to which the write data is written, or an area in the memory.

According to the embodiments of the invention, in a storage device which is supplied with a power supply voltage from a power supply and writes write data to a recording medium, a power supply voltage and a threshold voltage are compared and a comparison result is output. When it is determined, based on the comparison result, that the power supply voltage is lower than the threshold voltage immediately before write data is written to a recording medium, the write data is saved in a save area and the saved write data is written to the recording medium.

This makes it possible to reliably prevent data corruption due to power supply cut off, and also to meet the need for size and cost reduction of a storage device.

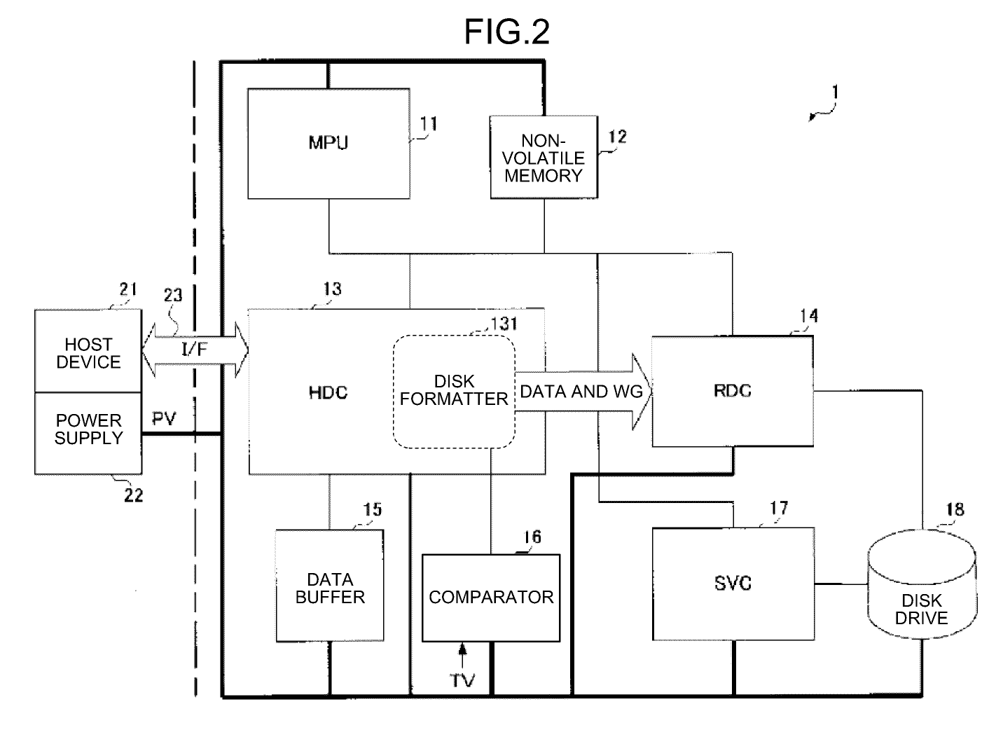

FIG. 2 is a block diagram of a storage device according to an embodiment of the invention. The embodiment is applied to a magnetic disk device using a magnetic disk as a recording medium. For convenience of description, FIG. 2 illustrates an example in which a magnetic disk device 1 constituting a storage device is connected to a host device 21 of a general purpose computer through an interface (I/F) 23, and a power supply voltage is supplied from a power supply 22. In FIG. 2, a thin solid line indicates a signal line and a thick solid line indicates a power supply line.

The magnetic disk device 1 comprises a processor or a micro processing unit (MPU) 11, a nonvolatile memory 12, a hard disk controller (HDC) 13 comprising a disk formatter 131, a read channel (RDC) 14, a data buffer 15, a comparator 16, a servo controller (SVC) 17, and a disk drive 18, which are connected as illustrated in FIG. 2. While the MPU 11 is employed as a processor in the embodiment, it may be a central processing unit (CPU), a microcomputer unit (MCU), or the like. The HDC 13 and the comparator 16 constitute a control device.

The MPU 11 controls the overall operation of the magnetic disk device 1. The nonvolatile memory 12 stores programs to be executed by the MPU and various kinds of data, and can constitute a save area described later. The HDC 13 controls input and output to and from the disk drive 18. The disk formatter 131 controls read data and write data with respect to the disk drive 18. The RDC 14 controls reading data from and writing data to the disk drive 18. The data buffer 15 constitutes a cache region for temporarily storing the read data and the write data. The comparator 16 compares a power supply voltage PV from the power supply 22 and a threshold voltage TV and outputs the comparison result to the HOC 13. Accordingly, the disk formatter 131 receives the comparison result obtained by comparing the power supply voltage PV and the threshold voltage TV. The SVC 17 controls seek operation of the disk drive 18. The disk drive 18 has a known structure comprising a head provided to an actuator and a magnetic disk. If there are a plurality of magnetic disks, the number of heads increases correspondingly to the number of the magnetic disks. The magnetic disk of the disk drive 18 can constitute a save area described later.

The basic configuration of the magnetic disk device 1 except the comparator 16 is known, and its detailed description is omitted. Note that the basic configuration of the magnetic disk device 1 is not limited to that illustrated in FIG. 2.

In the embodiment, the comparator 16 is provided outside the HDC 13, and is separate from the HDC 13. However, the comparator 16 may be provided in the HDC 13 and integrated with the HDC 13.

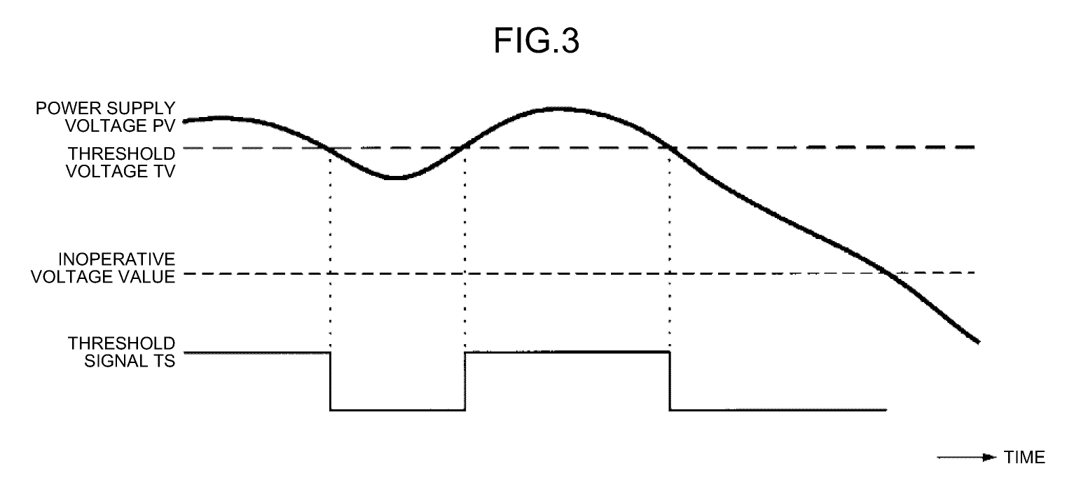

In the embodiment, the threshold voltage TV for comparison with the power supply voltage PV is input to the comparator 16. The disk formatter 131 of the HDC 13 has the function of checking, immediately before writing of each sector on the magnetic disk, whether the power supply voltage PV is lower than the threshold voltage TV. This check function is only required to determine the on/off (high/low level) state of a threshold signal TS as illustrated in FIG. 3. FIG. 3 is a chart for explaining operation upon cut-off of power supply. FIG. 3 illustrates a relationship among the power supply voltage PV, the threshold voltage TV, and the inoperative voltage value, and the threshold signal TS described later. The threshold voltage TV is set to be higher than the inoperative voltage value and lower than a specified value of the power supply voltage PV. For example, in the case where the specified value of the power supply voltage PV is +5.0 V and the inoperative voltage value is +4.2 V, the threshold voltage TV is set to +4.7 V.

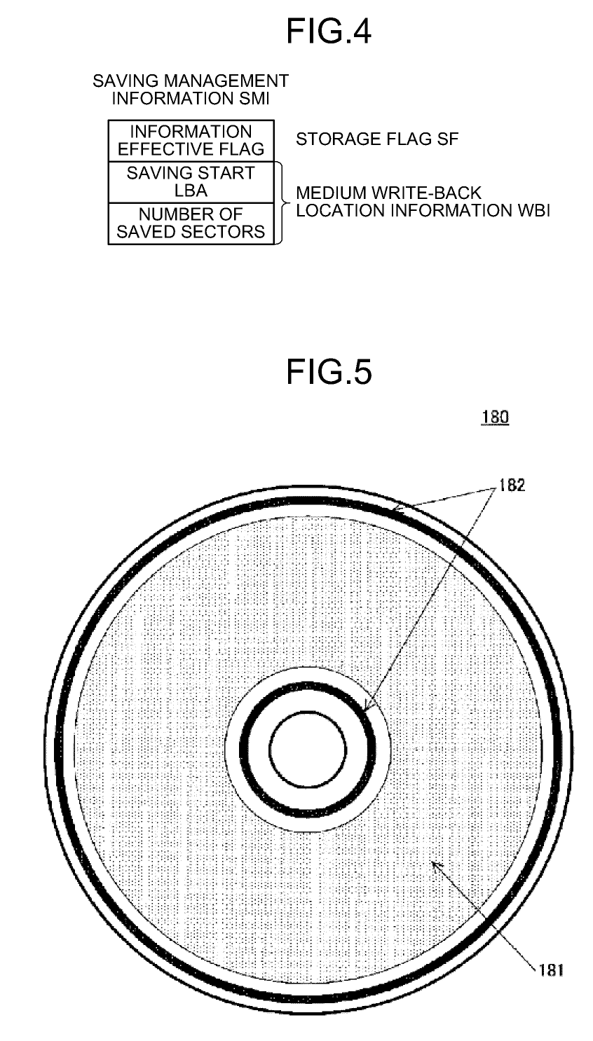

To temporarily store write data corresponding to an arbitrary number of sectors, a save area is provided on a magnetic disk or in the nonvolatile memory 12. This save area stores a storage flag SF and medium write-back location information WBI as illustrated in FIG. 4, described later, as saving management information SMI. FIG. 4 illustrates an example of the saving management information SMI. In the example of FIG. 4, the storage flag SF is constituted of an information valid flag, and the medium write-back location information WBI is constituted of a saving start logical block address (LBA) and the number of saved sectors. FIG. 5 is a plan view of areas on a magnetic disk 180 of the disk drive 18. As illustrated in FIG. 5, on the magnetic disk 180, save areas 182 are provided in an inner circumferential portion and an outer circumferential portion of the magnetic disk 180 with a user-use area 181 therebetween. The user-use area 181 is a region used by a user for storing user data such as write data. Note that the locations of the save areas 182 are not limited to the inner circumferential portion and the outer circumferential portion of the magnetic disk 180, and the number of save areas 182 only have to be one or more.

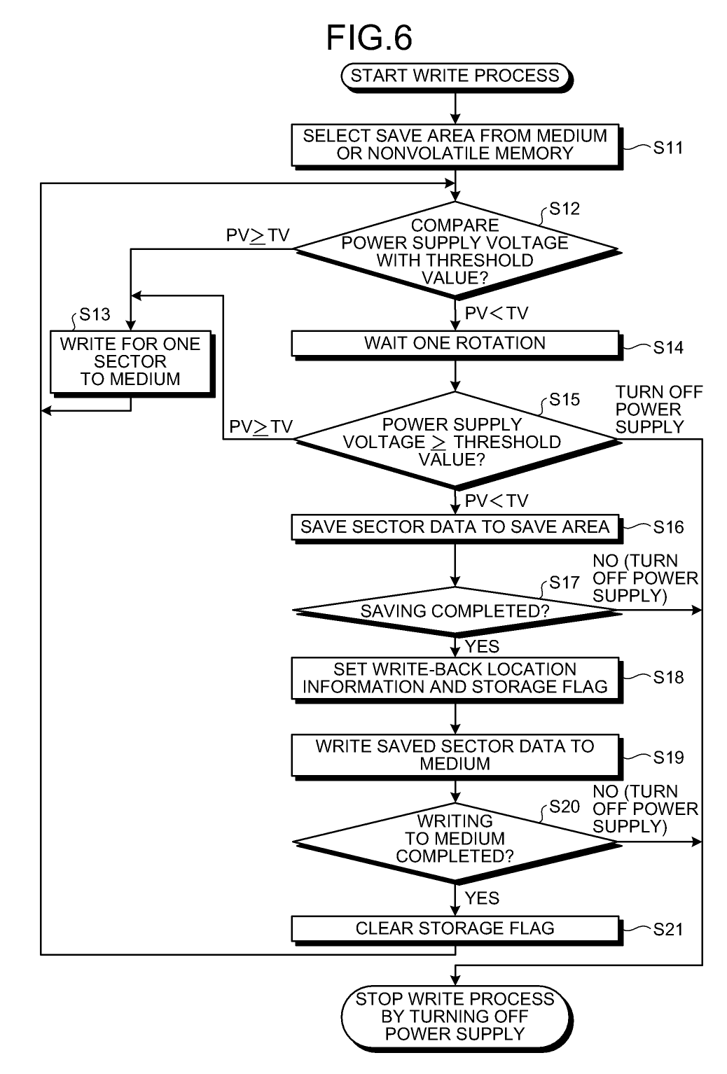

FIG. 6 is a flowchart of the write operation of the magnetic disk device 1. The process of FIG. 6 starts when a write request (or a write command) is issued from the host device 21 to the magnetic disk device 1, and is performed by the HDC 13 under the control of the MPU 11. The process of FIG. 6 is feasible with the disk formatter 131 in the HDC 13. At S11, a save area is selected. Specifically, the save area 182 on the magnetic disk 180 or the save area in the nonvolatile memory 12 is selected. The save area maybe selected from the host device 21 by a user, or may be selected in advance as default.

At S12, it is determined whether a comparison result output from the comparator 16, which compares the power supply voltage PV and the threshold voltage TV, represents that the power supply voltage PV is equal to or higher than the threshold voltage TV, or represents that the power supply voltage PV is lower than the threshold voltage TV. The comparison result output from the comparator 16 is the threshold signal TS illustrated in FIG. 3. For example, in on-state (high level), the threshold signal TS represents that the power supply voltage PV is equal to or higher than the threshold voltage TV. On the other hand, in off-state (low level), the threshold signal TS represents that the power supply voltage PV is lower than the threshold voltage TV. If the comparison result output from the comparator 16 represents that the power supply voltage PV is equal to or higher than the threshold voltage TV at S12, then at S13, write data corresponding to one sector, which is input from the host device 21, is written to the user-use area 181 on the magnetic disk 180, and the process returns to S12. On the other hand, if the comparison result output from the comparator 16 represents that the power supply voltage PV is lower than the threshold voltage TV at S12, then at S14, the magnetic disk device 1 waits without writing the write data to the magnetic disk 180 for a predetermined time, for example, a time during which the magnetic disk 180 rotates once, and then the process proceeds to S15. At S15, it is determined whether the comparison result output from the comparator 16 represents that the power supply voltage PV is equal to or higher than the threshold voltage TV, that the power supply voltage PV is lower than the threshold voltage TV, or that the power supply voltage PV is approximately zero and the power supply 22 is turned off. If the comparison result output from the comparator 16 represents that the power supply voltage PV is equal to or higher than the threshold voltage TV at S15, it means that the power supply voltage PV has returned to a value equal to or higher than the threshold voltage TV. The process therefore returns to S13, at which write data corresponding to one sector is written to the user-use area 181 on the magnetic disk 180.

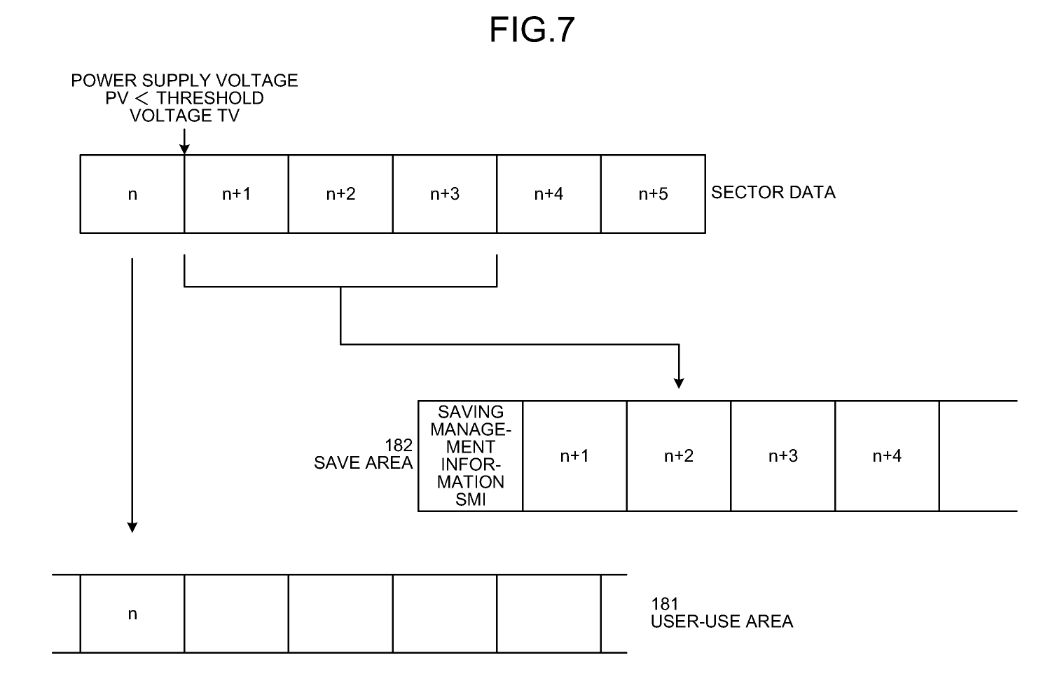

If the comparison result output from the comparator 16 represents that the power supply voltage PV is lower than the threshold voltage TV at S15, then at S16, write data corresponding to an arbitrary number of sectors is saved to the selected save area. At this point, the number of sectors of write data written to the selected save area can be arbitrarily set. However, the number of sectors is preferably one that allows the writing to be performed continuously without seeking in writing the write data to the user-use area 181. FIG. 7 is a diagram for explaining writing of write data to the selected save area. FIG. 7 illustrates an example where the selected save area is the save area 182 on the magnetic disk 180, and write data of three sectors is written to the save area 182. In FIG. 7, n, n+1, . . . represent sector numbers of write data, i.e., sector data (n: an integer equal to or greater than 1).

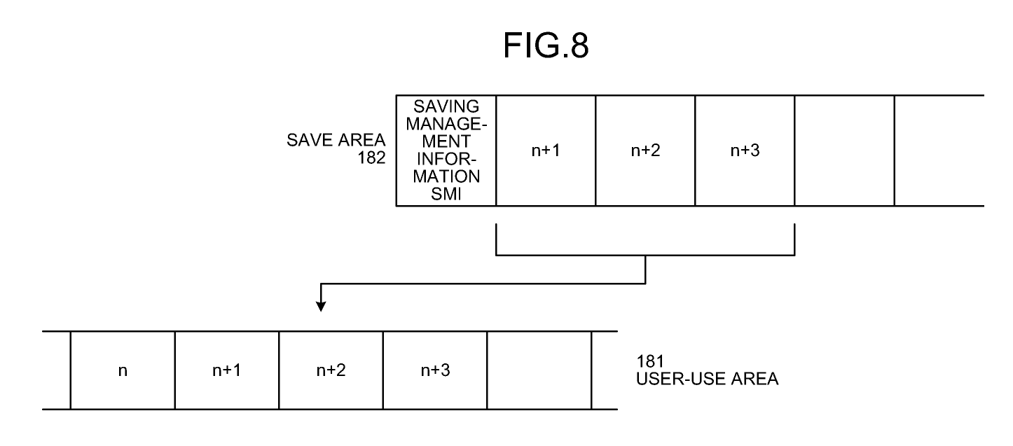

At S17, it is determined whether saving of write data corresponding to one sector to the selected save area is completed. If the saving is completed (YES at S17), then at S18, the storage flag SF and the medium write-back location information WBI as illustrated in FIG. 4 are set in the selected save area. At S19, the write data corresponding to the arbitrary number of sectors saved to the selected save area is written to the user-use area 181 on the magnetic disk 180. FIG. 8 is a diagram for explaining writing of the write data saved in the selected save area to the user-use area 181 on the magnetic disk 180. FIG. 8 illustrates an example where the selected save area is the save area 182 on the magnetic disk 180, and write data of three sectors (i.e., the arbitrary number of sectors) is written to the save area 182, as in FIG. 7. In FIG. 8, n, n+1, . . . represent sector numbers (n: an integer equal to or greater than 1).

At S20, it is determined whether writing of the saved write data corresponding to one sector to the user-use area 181 on the magnetic disk 180 is completed. If the writing is completed (YES at S20), then at S21, the storage flag SF of the selected save area is cleared, and the process returns to S12.

If the comparison result output from the comparator 16 represents that the power supply 22 is turned off at S15, then the writing is stopped due to this. In this case, the writing is stopped before write data is written to the user-use area 181 of the magnetic disk 180. This avoids corruption of write data that has already been written to the user-use area 181.

If the saving is not completed (NO at S17), then the writing is stopped because the power supply 22 is turned off. In this case, the writing is stopped while the write data is being saved to the selected save area. The write data of the selected save area is therefore corrupted, but corruption of write data that has already been written to the user-use area 181 is avoided.

If the writing is not completed (NO at S20), then the writing is stopped because the power supply 22 is turned off.

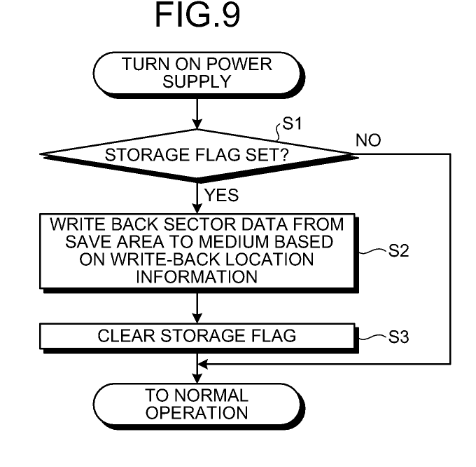

FIG. 9 is a flowchart of the operation of the magnetic disk device 1 upon turning on the power supply. The process of FIG. 9 starts when the power supply 22 is turned on to supply the power supply voltage PV to the magnetic disk device 1, and is performed by the HDC 13 under the control of the MPU 11. At S1, it is determined whether the storage flag SF is set in the save area 182 on the magnetic disk 180 or in the nonvolatile memory 12. If the storage flag SF is set (YES at S1), then at S2, the write data (i.e. , sector data) stored in the save area is written back to the user-use area 181 on the magnetic disk 180 based on the medium write-back location information WBI stored in the save area 182 on the magnetic disk 180 or in the save area in the nonvolatile memory 12. At S3, the storage flag SF stored in the save area is cleared. If the storage flag SF is not set (NO at S1), or after S3, the process moves to normal operation, such as writing or reading, of the magnetic disk device 1.

Thus, even if the power supply 22 is turned off while write data is being written to the user-use area 181 on the magnetic disk 180, the storage flag SF stored in the selected save area (e.g., the save area 182 on the magnetic disk 180) remains set. Therefore, upon next turning on the power supply 22 of the magnetic disk device 1, if it is confirmed that the storage flag SF is set, write data (i.e., sector data) stored in the save area can be written back to the user-use area 181 on the magnetic disk 180 based on the medium write-back location information WBI. After such writing back of the write data to the user-use area 181, the storage flag SF stored in the save area is cleared. This enables sector data corrupted in the user-use area 181 on the magnetic disk 180 to be successfully written back.

As described above, according to the embodiment, writing is advanced while sector data is saved to a save area based on simple comparison between a power supply voltage and a threshold voltage. This eliminates unnecessary interruption of the writing. Even if, after saving the sector data to the save area, sector data corruption occurs due to power supply cout off while the sector data is being written to a normal position on a recording medium, it becomes possible upon turning on again the power supply to restore the sector data corrupted on the recording medium to its original state from the sector data saved in the save area. With this, data corruption due to power supply cut off can be reliably prevented. Further, it is not necessary to provide an additional component such as a built-in power supply. Therefore, data corruption due to power supply cut off can be prevented at low cost with a relatively simple and downsized configuration.

While write data has been described in the above embodiment as being stored on sector basis on a magnetic disk, it is not so limited, and write data may be stored on any basis. The recording medium is not limited to a magnetic disk and may be any type of recording medium, such as an optical disk, a magneto-optical disk, and a card-type recording medium.

The various modules of the systems described herein can be implemented as software applications, hardware and/or software modules, or components on one or more computers, such as servers. While the various modules are illustrated separately, they may share some or all of the same underlying logic or code.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. A control device of a storage device that is supplied with a power supply voltage from a power supply and writes write data to a recording medium, the control device comprising:
an input module configured to receive a comparison result obtained by comparing the power supply voltage with a threshold voltage; and
a controller configured to save the write data to a save area when determining, immediately before writing the write data to the recording medium, that the power supply voltage is lower than the threshold voltage based on the comparison result, and write the write data saved in the save area to the recording medium.

2. The control device of claim 1, wherein
the controller is configured to determine, immediately before writing the write data to the recording medium, whether the power supply voltage is lower than the threshold voltage for a predetermined time or longer based on the comparison result, and
the controller is configured to save the write data to the save area when the power supply voltage is lower than the threshold voltage for the predetermined time or longer, and write the write data to the recording medium when the power supply voltage is lower than the threshold voltage for less than the predetermined time.

3. The control device of claim 2, wherein the controller is configured to stop writing of the write data to the recording medium when determining, immediately before writing the write data to the recording medium, that the power supply voltage is cut off for a predetermined time or longer based on the comparison result.

4. The control device of claim 1, wherein the controller is configured to save to the save area, together with the write data, a storage flag to be set when the write data saved in the save area is valid, and location information indicating a write-back location in the recording medium.

5. The control device of claim 4, wherein the controller is configured to clear the storage flag upon completion of writing of the write data saved in the save area to the recording medium.

6. The control device of claim 4, wherein the controller is configured to stop writing of the write data to the recording medium when saving the write data to the save area is not completed or when writing of the write data saved in the save area to the recording medium is not completed.

7. The control device of of claim 4, wherein the controller is configured to write back the write data saved in the save area to the recording medium based on the location information when the storage flag is set upon next turning on the power supply.

8. The control device of claim 1, wherein
the recording medium is a disk, and
the controller is configured to save the write data to the save area on sector basis, and write the write data saved in the save area to the recording medium on sector basis.

9. The control device of claim 1, wherein the save area comprises an area on the recording medium other than an area to which the write data is written, or a storage area other than the recording medium in the storage device.

10. A storage device that is supplied with a power supply voltage from a power supply and writes write data to a recording medium, the storage device comprising:
a processor configured to control the storage device;
a memory configured to store data and a program to be executed by the processor;
a comparator configured to compare the power supply voltage with a threshold voltage and output a comparison result; and
a controller configured to, under control of the processor, save the write data to a save area when determining, immediately before writing the write data to the recording medium, that the power supply voltage is lower than the threshold voltage based on the comparison result, and write the write data saved in the save area to the recording medium,
wherein the save area comprises an area on the recording medium other than an area to which the write data is written, or an area in the memory.

11. The storage device of claim 10, wherein
the controller is configured to determine, immediately before writing the write data to the recording medium, whether the power supply voltage is lower than the threshold voltage for a predetermined time or longer based on the comparison result, and
the controller is configured to save the write data to the save area when the power supply voltage is lower than the threshold voltage for the predetermined time or longer, and write the write data to the recording medium when the power supply voltage is lower than the threshold voltage for less than the predetermined time.

12. The storage device of claim 11, wherein the controller is configured to stop writing of the write data to the recording medium when determining, immediately before writing the write data to the recording medium, that the power supply voltage is cut off for a predetermined time or longer based on the comparison result.

13. The storage device of claim 10, wherein the controller is configured to save to the save area, together with the write data, a storage flag to be set when the write data saved in the save area is valid, and location information indicating a write-back location in the recording medium.

14. The storage device of claim 13, wherein the controller is configured to clear the storage flag upon completion of writing of the write data saved in the save area to the recording medium.

15. The storage device of claim 13, wherein the controller is configured to stop writing of the write data to the recording medium when saving the write data to the save area is not completed or when writing of the write data saved in the save area to the recording medium is not completed.

16. The storage device of claim 13, wherein the controller is configured to write back the write data saved in the save area to the recording medium based on the location information when the storage flag is set upon next turning on the power supply.

17. The storage device of claim 10, wherein
the recording medium is a disk, and
the controller is configured to save the write data to the save area on sector basis, and write the write data saved in the save area to the recording medium on sector basis.

18. The storage device of claim 10, wherein the comparator is located in the controller or outside the controller.
